(19) United States
(12) Patent Application Publication
(10) Pub. No.: US 2002/0078567 A1
(43) Pub. Date: Jun. 27, 2002

(54) Method of manufacturing rings for a starter using a press

(76) Inventor: Michihiro Yokoyama, Anjo-city (JP)

Correspondence Address: ARMSTRONG,WESTERMAN & HATTORI, LLP, 1725 K STREET, NW., SUITE 1000, WASHINGTON, DC, 20006, US

(21) Appl. No.: 09/520,995

(22) Filed: Mar. 8, 2000

(30) Foreign Application Priority Data
Jul. 6, 1998 (JP) 10-225094

(51) Int. Cl. B23P 15/14

(52) U.S. Cl. 29/893.3

(57) ABSTRACT

A coil maerial of special steel is cut and a ring coil for starter is formed, and both ends of the ring coil material for starter are connected thereby a ring-shaped material is formed. Two different machining works, a tooth part punching work and a chamfer part forming work, can be performed at one step. That is, the two different machining works can be performed by one press, and since the applied pressure is distributed in each step, the manufacturing in a small press becomes possible.

### BACKGROUND OF THE INVENTION

1. Field of the Invention

The present invention relates to a method of manufacturing rings for a starter using a press,

wherein rings for a starter (including a ring gear for automatic transmission) are manufactured using a press in a method of one step that punching of tooth form in a gear and chamfering of a part of the gear are performed in one step, or in a method of two steps that crush molding is performed at the first step and punching of the tooth form in the gear and chamfering of a part of the gear are performed at the second step.

2. Prior Art

In the prior art, the manufacturing has been performed in that a flat bar material is curled and then welded in flush butt welding, and using a lathe or the like, the inside and the outside and both end surfaces are machined in the cutting work, and then gear cutting work is performed by a hobbing machine and chamfering work is added. Consequently a tooth part from the bar material and a chamfer are all manufactured by the cutting work. However, although the manufacturing time is required, the precision is bad and the manufactured articles are classified in 5th class or 6th class in the JIS standard.

### SUMMARY OF THE INVENTION

In a method of the prior art much time is required for manufacturing a ring gear from a flat bar material, for cutting work of the inner diameter, the outer diameter to he both end surfaces, for the gear cutting work and for the chamfering work. Therefore a problem exists in that the manufacturing time becomes long. In order to solve such problems in the prior art, an object of the present invention is to provide a method of manufacturing a ring gear and a drive plate gear where a taper part with stages is provided to female dies thereby the machining precision is improved, and the cutting work is entirely abolished and the machining time is greatly reduced.

The machining work is characterized in that a coil material of special steel is cut and a ring coil for starter is formed, and both ends of the ring coil material for starter are connected thereby a ring-shaped material is formed, or a plate in a plate material of special steel is machined in cutting work and a ring-shaped material for starter is performed from the ring-shaped material, and particularly that two different machining works, a tooth part punching work and a chamfer part forming work, can be performed at one step. That is, the two different machining work can be performed by one press, and since the applied pressure is distributed in each step and machining is performed, the manufacturing in a small press becomes possible in compariaon with a machining method in the prior art. Also a ring gear and a drive plate gear having productivity and being cheap can be provided, or the working force is reduced thereby the life of the metal mold can be mde long greatly and the cost can be reduced

Either a method of coil material of special steel is cut and a ring coik material for starter is formed, and both ends of the ring coil material are connected and a ring-shaped material is formed, or a method that a plate constituted by a plate material of special steel is machined in cutting work and a ring-shaped material for starter is machined, may be adopted. In comparison with machining that a ring material is formed from the ring-shaped material and a tooth form is machined in cutting to the ring material, since the present invention performs machining by a press, the productivity becomes rapid at least in 20 times and the precision of the product is constant and the product can be provided at low cost.

### BRIEF DESCRIPTION OF DRAWINGS

FIG. 1 is a sectional view showing materials, and FIG. 1a, a′ show ring-shaped materials, FIG. 1b˜e show ring materials 1b, 1c, 1d, 1e, FIG. 1f shows a drive plate material 1f,

FIG. 2 is a perspective view showing forming process of a ring-shaped material, and FIG. 2(a) shows a ring coil material, and FIG. 2(b) shows a ring-shaped materials;

FIG. 3 is a sectional view of a metal mold for molding a ring-shaped material;

FIG. 4 is a sectional view of a metal mold for crush molding of outer circumference of a ring material;

FIG. 5 is a sectional view of a metal mold for punching of a tooth form of a ring gear and for chamfering molding;

FIG. 6 is a sectional view where two metal molds are arranged in parallel within one die set;

FIG. 7 is a sectional view of a metal mold for crush molding of outer circumference of a drive plate material;

FIG. 8 is a sectional view of a metal mold for punching a tooth form of a gear of a drive plate material and for chamfering molding;

FIG. 9 is a diagram showing punching fall portion of a front of a tooth of a ring gear;

FIG. 10 is a detailed view of the inside of a female die;

FIG. 11 is a diagram showing a space of 5 mm in the indide of the female die where the applied pressure becomes free;

FIG. 12 is a diagram showing crowning portion of the completed gear;

FIG. 13 is a diagram showing punching scrap of a gear ring remaining at outer circumference of a punch;

FIG. 14 is a diagram showing a ring-shaped large punching scrap generated during punching of a tooth form of a gear removed from a punch of the gear and a punching scrap newly generated at upper side of a punch of the gear; and

FIG. 15 is a diagram showing state that press machining is entirely finished and chamfering is provided at the gear.

### DESCRIPTION OF PREFERRED EMBODIMENTS

Embodiments of the present invention will be described based on the accompanying drawings. FIG. 1 shows general ring-shaped materials 1a, 1a′, ring materials 1b, 1c, 1d, 1e and a drive plate material 1f in diagram showing a part of essential part together with sectional view in enlarged state respectively.

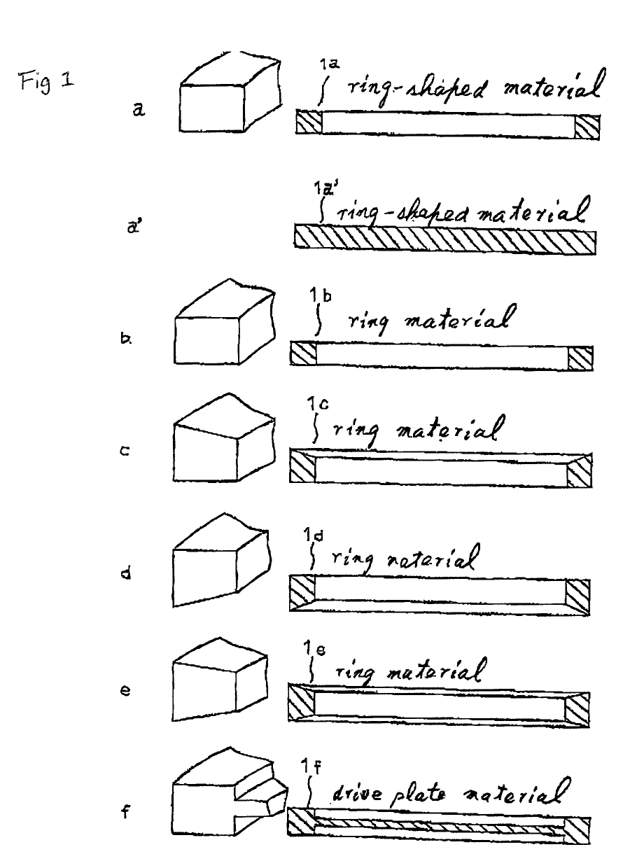

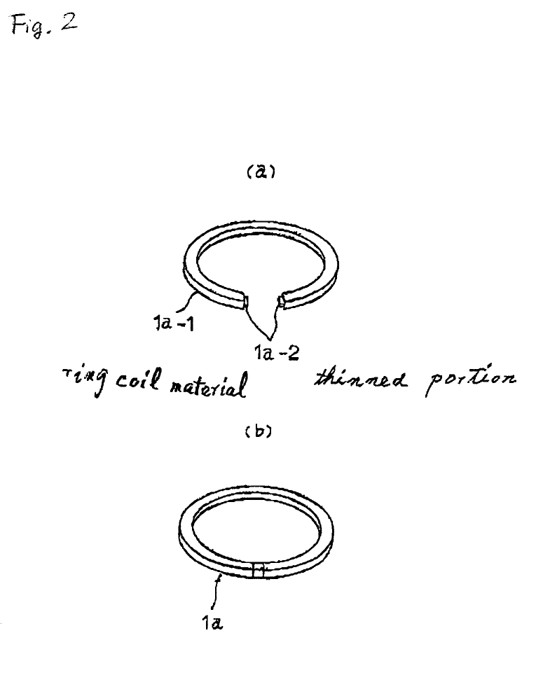

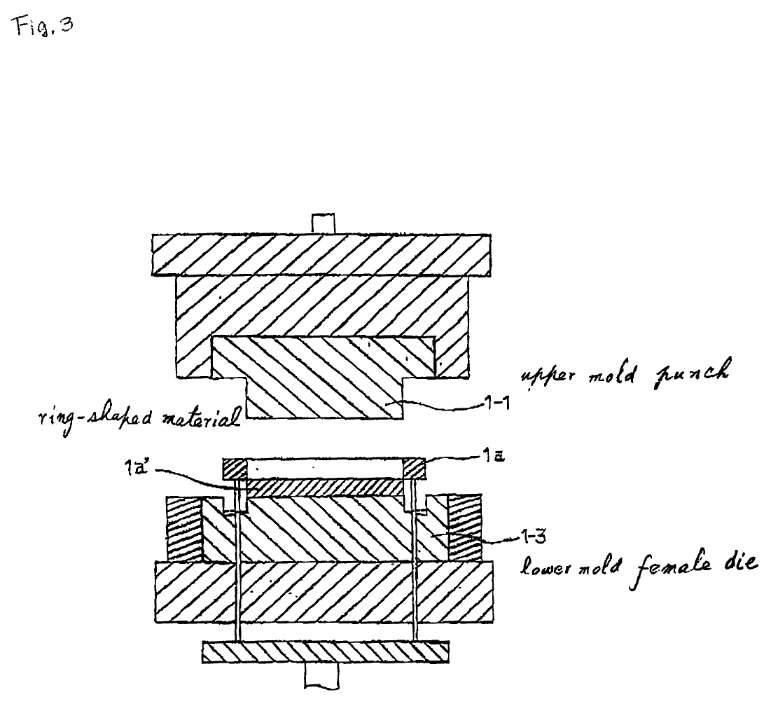

FIG. 2(a), (b) shows a state that a coil material of special steel is cut and a ring coil material for starter is formed, and both ends of a coil material 1a-1 are thinned 1a-2, 1a-2, and connected by the welding or the like, and the connection portion is formed flatly, and the ring-shaped material for starter is machined. Also FIG. 3 shows a state that from a plate material of special steel, utilizing an upper mold punch 1-1 and a lower mold female die of the metal mold for molding, the ring-shaped material 1a′ for starter is machined by press manufacturing method.

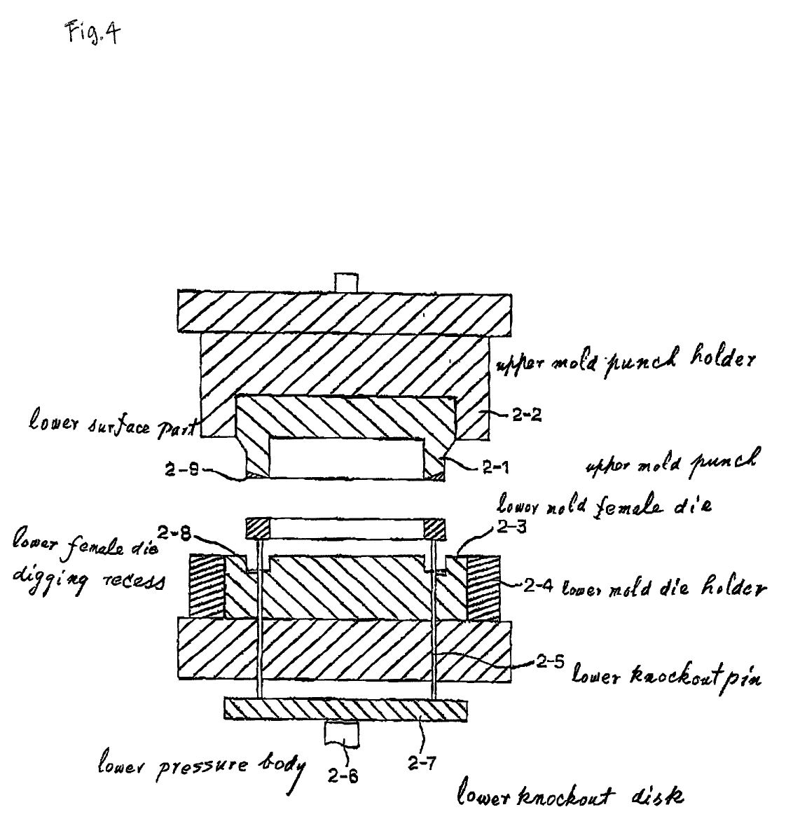

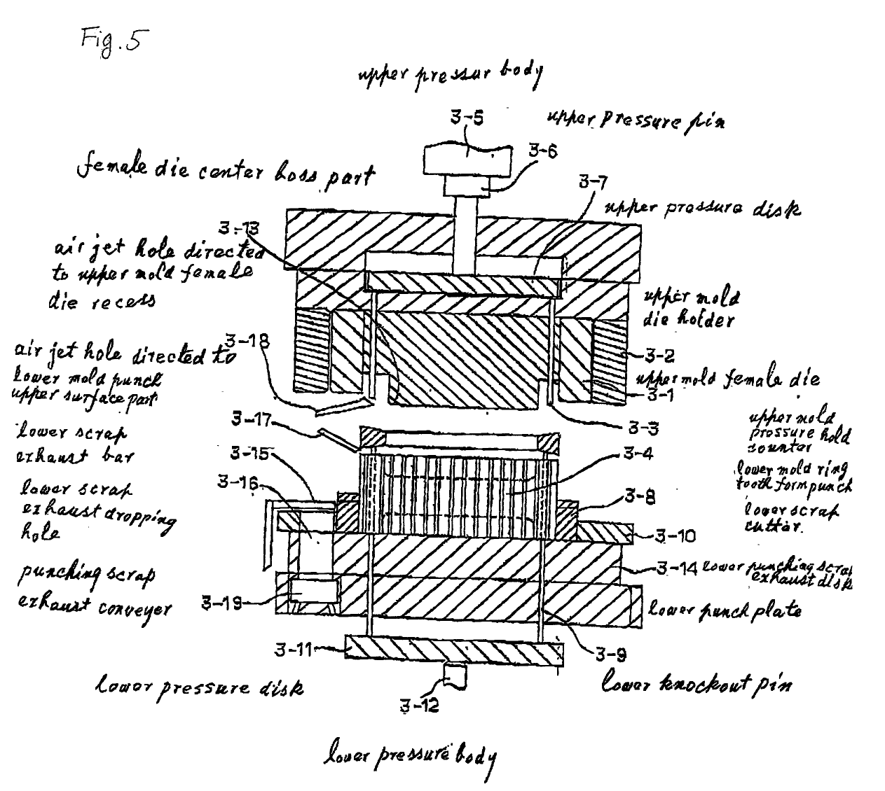

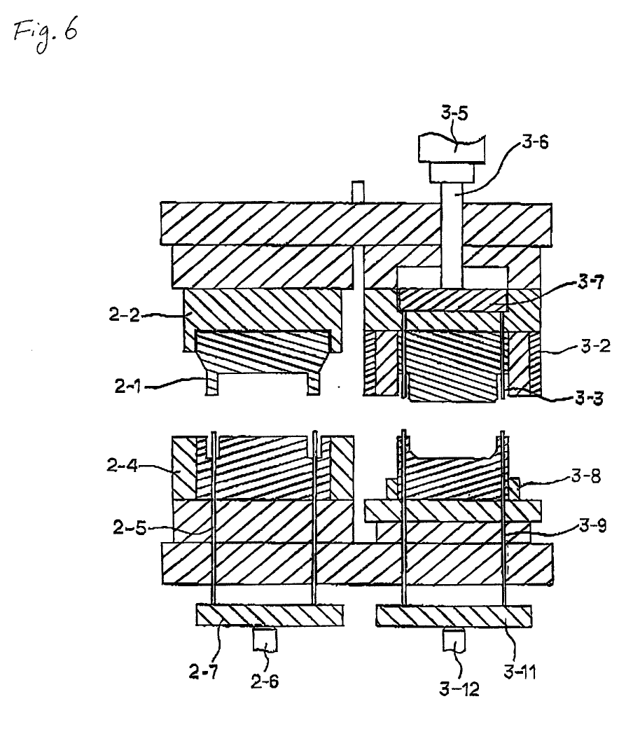

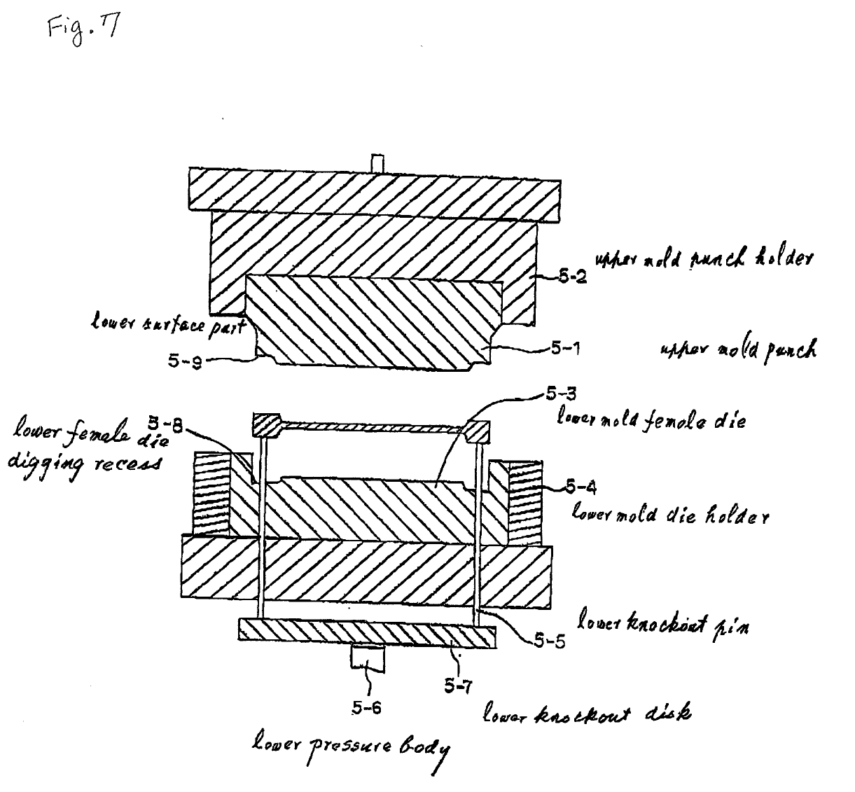

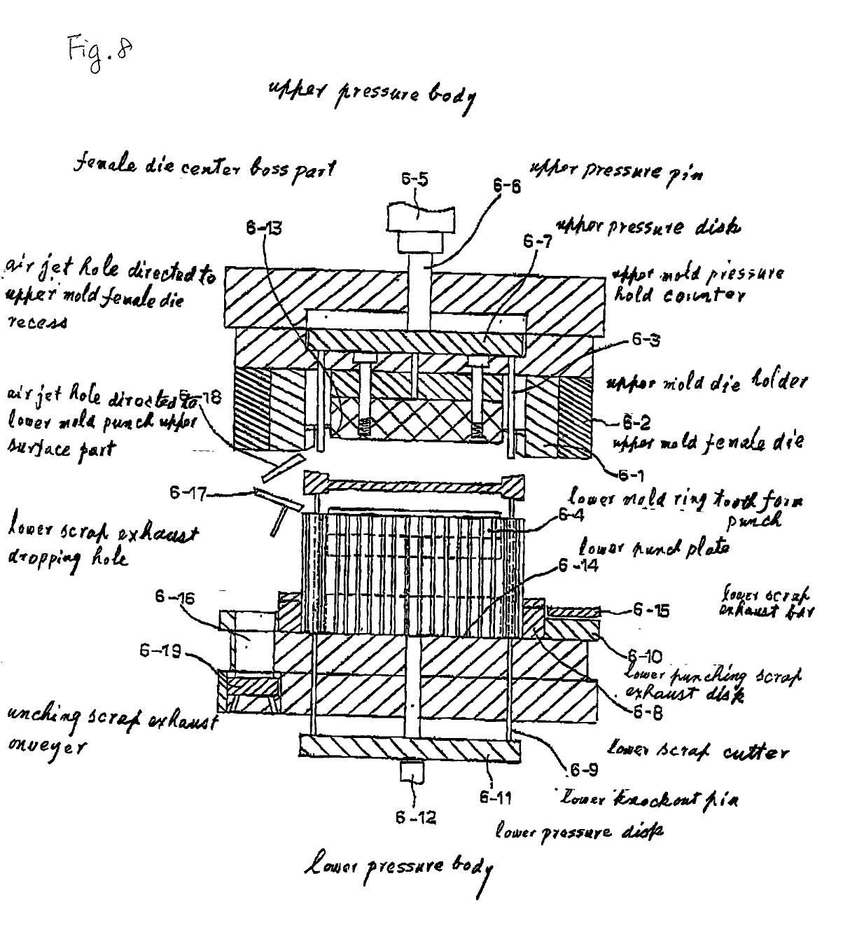

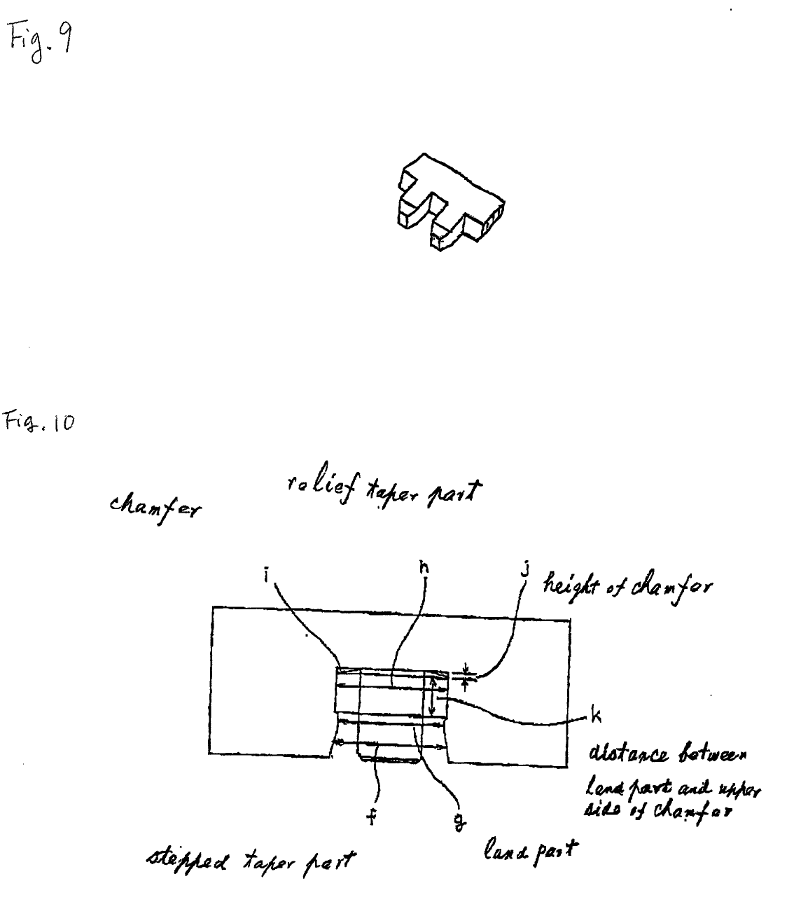

FIG. 4 is a sectional view of a metal mold for thickness crush molding of a ring material 1b . FIG. S is a sectional view of a metal mold for punching of a tooth form of a gear and for pushing molding of a chamfer. In FIG. 6, two metal molds, a metal mold of FIG. 4 to the left and a metal mold of FIG. 5 to the right, are arranged in parallel and two different machining works are performed simultaneously by one press, and work hardening which may be generated after the first crush molding work can be avoided. That is, the work is rapidly performed within 2˜6 seconds of the second machining work, thereby the second machining work is finished before generating the work hardening. If a material 1a, a ring material 1b or a drive plate material 1f being left intact is subjected to press machining, punching fall (refer to FIG. 9) is produced at front of tooth. Therefore the crush molding of the material thickness is performed, and machining is applied to sectional shape of any of the ring materials 1c, 1d, 1e . However, in the mass-production machining of the ring material 1c, 1d, 1e or the drive plate material 1f, if shape of any of the ring materials 1c, 1d, 1e can be manufactured at low cost in the existing general facilities manufacturing the ring material 1b to the drive plate material 1f punching of tooth form in the gear of FIG. 5 and molding work of the chamfer can be performed directly and the machining of the ring material 1b (refer to FIG. 4) and the drive plate material 1f (refer to FIG. 7) or the crush molding maybe omitted.

In the machining using the ring material 1b to the drive plate material 1f, the outer ference diameter of the ring material 1b and the drive plate material 1f is Φ 300 and the thickness is 11 mm. The crush molding machining of the thickness of ring material 1b in FIG. 4 is performed at first, and the ring material 1b is set to the upper surface part of the lower mold female die 2-3 and the drive plate material 1f is set to the lower mold female die 5-3 of the lower mold die holders 2-4 to 5-4. The upper mold has upper punches 2-1 to 5-1. There is a cylindrical lower mold female die digging recess 2-8 or 5-8 into which the ring material 1b is entered from the upper surface part of the lower mold female die 2-3, and the lower mold female die digging recess 2-8 or 5-8 is dug deep from 30% to 50% of the thickness of the ring material 1b. In the digging bottom part, depth from the inner circumference bottom part to the outer circumference bottom part is varied, thereby the ring materials 1c, 1d can be manufactured. In the lower mold female die 2-3 or 5-3 and the lower surface part 2-9 or 5-9 of the ring-shaped upper punch 2-1 or 5-1, the inner circumferential side is varied long from the outer circumferential side, thereby the ring material 1d can be manufactured. Thickness of the circumferential part of the ring material 1e is 13 mm, and thickness of the inner circumferential part is 10 mm.

The ring material 1b to the drive plate material 1f are held on the lower knockout pin 2-5 to 5-5 projecting from the upper surface side of the female die. If the slide of the press starts the falling, the upper punch holder 2-2 or 5-2 of the upper punch 2-1 or 5-2 of the upper punch 2-1 or 5-1 abuts on the ring material 1b or the drive plate material 1f. Since the applied pressure of the lower part knockout pin is smaller than the punch pressure, it is easily sunk together with the ring material 1b or the drive plate material 1f downward, and is entered into the lower mold female die digging recess 5-8. Then the ring material 1b or the drive plate material 1f abuts on the wall of the inner diameter and the outer diameter in the digging part and can not be expanded, and the moving of the body to the thickness direction occurs. In the sectional shape of the ring material 1b or the drive plate material 1f, among the ring material 1c, 1d, 1e from the ring material 1b and the drive plate material 1f, due to the shape of the dug bottom part of the lower female die 5-3 and the shape of the lower surface part of the lower ring tooth form punch 3-4 or 6-4, the ring material 1d can be manufactured in the present machining. In addition, the lower part knockout pin 2-5 or 55 is supported by a lower part knockout disk 2-7or 5-7 provided at the lower part pressure body 2-6 or 5-6.

Within the lower mold female die digging recess 2-8 or 5-8, the ring material 1b or the drive plate material 1f is expanded to the wall of the inner diameter and the outer diameter and is stuck thereto, and in the state that the ring material 1b or the drive plate material 1f is left to the lower mold female die digging recess 2-8 or 5-8, the slide of the press rises and at the same time the lower part knock out pin 2-5 or 5-5 elevates the ring material 1b or the drive pin material 1f left within the lower mold die 2-3 or 5-3 to prescribed position at the upper surface of the lower mold female die 2-3 oe 5-3 thus the machining is finished.

In this step, that the sectional shape of the ring material 1b is deformed, in order to improve the precision of the ring material 1b necessary during the tooth part punching and the chamfer molding at next step, the precision in the degree of real circle of the inner diameter and the outer diameter or in the degree of real plane is raised thereby the production considering the improvement of the machining at next step and after finishing the machining is performed. In addition, since the material of special steel is used much and after this step, the work hardening occurs, moving to the metal mold in next step is rapidly performed and the machining is started within 5 seconds, thereby the influence of the work hardening is made minimum and the extension of the life of the metal mold or the reduction of the maintenance cost of the metal mold is intended.

In the ring material 1b or the drive plate material 1f or ring material 1e after finishing the first step, four lower knockout pins 3-9 and 6-9 exist at position elevated by 5 mm from the upper surface part of the lower mold ring tooth form punch 3-4 or 6-4 in FIG, 5 in ring-shaped equivalent positions and the ring material 1b or the drive plate material 1f is held on the lower knockout pins 3-9 and 6-9. On the other hand, the female die 3-1 or 6-1 is arranged at the upper mold, and at the lower side of the female die 3-1 or 6-1, the female die center boss part 3-13 or 6-13 having smaller inner diameter than that of the ring material 1b or the drive plate material 1f serves to positioning of the ring material 1b. If the slide of the press starts the falling, at first, the female die center boss part 3-13 or 6-13 is entered into the center hole side surface and depresses the lower part knockout pin 3-9 or 6-9 and performs the prescribed positioning on the punch. In addition, role of the lower knockout pin 3-9 or 6-9 is in that at the finishing of machining of the ring material 1b, the stuck state of the ring material is released and the exhaust is facilitated, and in that a gap is held between the upper surface part of the lower ring tooth form punch 3-4 or 6-4 and the ring material 1b so that a pawl of the feed device or person hands can easily enter the ring material 1b onto the lower mold ring tooth form punch 34 or 64 and exhaust it out of the metal mold. In addition, the lower knockout pin 3-9 or 6-9 is supported to the lower pressure body 3-12 or 6-12 provided at the lower part pressure disk 3-11 or 6-11.

Thereby the ring material 1b or the drive plate material 1f is led to the center position of the punch. Next the upper mold pressure holding counter 3-3 or 6-3 for pushing materials in up and down motion is arranged within the upper mold female die 3-1 or 6-1 of the upper die holder 3-2 or 6-2, and applies pressure to the upper surface part of the ring material 1b or the drive plate material 1f

The counters pushing the ring material 1b or the like are arranged at eight positions in cylindrical shape between the tooth form outer circumferential surface and the center boss part. The counters feed the applied pressure to depress the lower part knockout pins 3-9 or 6-9 from the pressure body 3-5 or 6-5 and the upper pressure disk 3-7 or 6-7 from the upper part. When the counter passes trough the bottom dead center, the counter serves to change the applied pressure into strong pressure.

When the ring material 1b is entered into the upper mold female die 3-1 or 6-1, the inside of the upper mold female die 3-1 or 6-1 comprises as shown in FIG. 10 a stepped taper part f, a land part g, a relief taper part h at inlet side, and a chamfer i at the deepest bottom part, and height j of the chamfer is provided. Distance k between the land part and the upper side of the chamfer is set longer than the thickness of the ring material 1b and is set to 15 mm in this case. The ring material 1b at first passes through the stepped taper part f, and next when it passes through the land part g, the punching of the tooth form of the gear is finished. The applied pressure necessary then is finished when it passes through the land part g. Then since the thickness of the ring material 1b or the drive plate material 1f being 13 mm is thinned to 10 mm at the outer circumferential part, when it passes through the land part, the distance to the upper side of the chamfer is 5 mm as shown in FIG. 11. In his distance 5 mm, the pressure of the press is restored to 0, and the applied pressure necessary at the molding pushing machining of the chamfer can supply the newly restored pressure. Therefore the press at the falling time performs the punching machining of the tooth form of the gear at first. The applied pressure necessary therefor can be suppressed to 500 tons being 50% or less of the machining of the general press, by the effect of the stepped taper part of the female tie. The stepped part can suppress the expansion or the contraction of the involute curve part and is the epock-making method,

The second maching being the chamfer pushing machining requires 500 tons. In the pressure gauge of the press, the total two values of the two machining works are indicated as 500 tons, and when the actual applied pressure is 500 tons, the machining can be finished. Therefore the used press being a press of 800 tons can perform the machining and considering the general work load (actually necessary applied pressure), 2,000 tons seems necessary. The used press requires 2,500 tons considering a margin. However, in the case of including the crush machining, 500 tons together with adding of 300 tons being the applied pressure necessary for the crush molding machining becomes the total 800 tons. Considering a margin, the machining is performed by a press of 1,000 tons. Consequently the reduction of the applied pressure is realized.

When the slide of the press attains to the bottom dead center, the ring material 1b or the drive plate material 1f is pushed by the upper pressure body 3-5 or 6-5 to the lower punch upper surface part by the upper mold pressure holding counter 3-3 or 6-3 thereby can not be moved. On the other hand, the upper mold female die 3-1 or 6-1 starts the rise when the chamfer molding is finished, and when the ring material 1b or the drive plate material 1f passes from the release part through the land part, the reverse passing to the falling state occurs. Then as shown in FIG. 12, crowning is generated at the gear part. When it passes through the stepped taper, the ring material 16 or the drive plate material 1f is released at the outer circumference from the upper mold female die 3-1 or 6-1. Still in this time point, the upper counter continues to supply pressure to the ring material 1b or the drive plate material 1f. When the upper mold female die 3-1 or 6-1 rises 5mm from the upper surface part the pressure of the counter is interrupted thereby the ring material 1b or the drive plate material 1f is released from all pressure and is elevated to the position of prescribed height 5mm by the lower knockout pins 3-9 and 6-9. Thereby machining of the gear and the chamfer is finished.

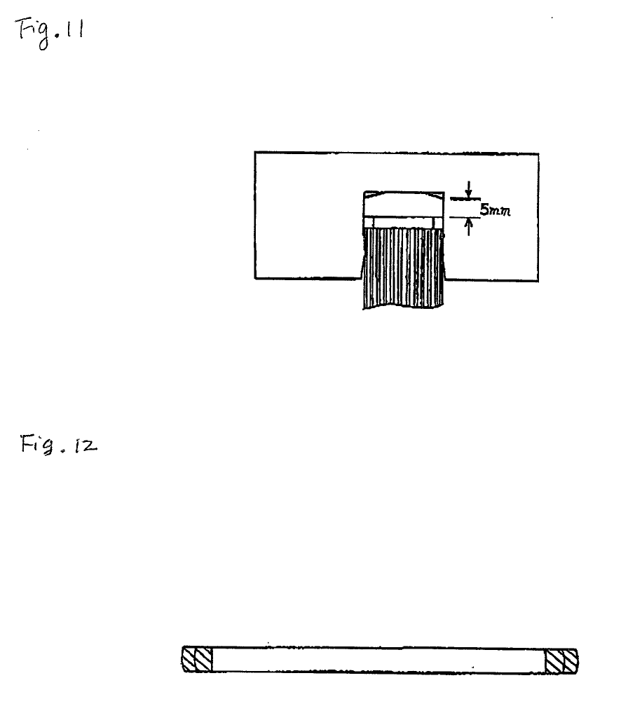

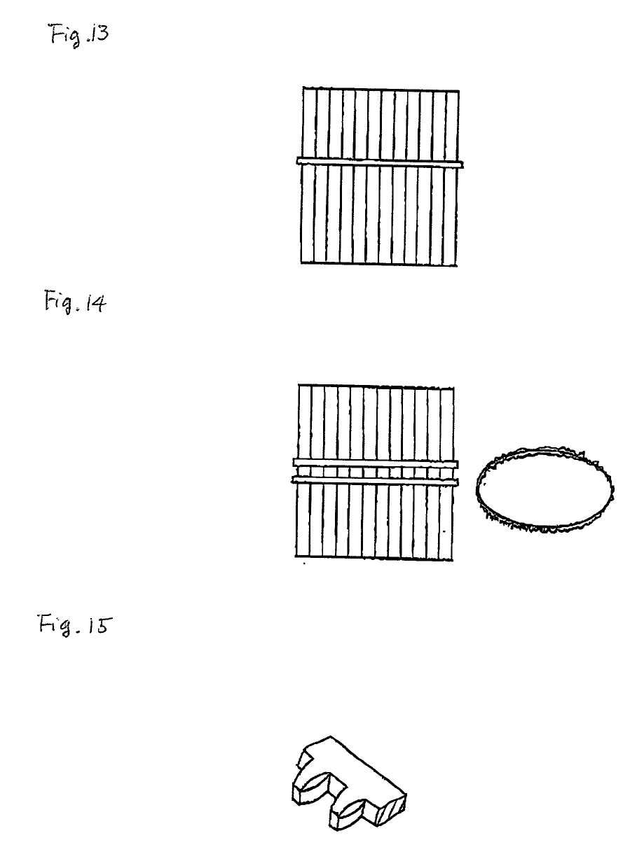

The ring punching scrap (refer to FIG. 13) generated at the punching state of tooth form of the gear remaining at the outer circumferential part of the lower punch remains at the outer circumferential part of the punch, and after the next machining, a new punching is generated, and from the upper surface of the punch outer circumferential part to the lower direction, one large punching scrap is depressed in sequence (refer to FIG. 14). Therefore the four scrap cutters 3-8 to 6-8 are provided at four positions to the punch lower direction and cutting is performed in sequence and the scrap distributed and cut into 4 pieces is dropped from the lower punching scrap discharge disk 3-10 to 6-10 and the dropped punching scrap is discharged by the lower scrap discharge bar 3-15 to 6-15 and through the lower scrap discharge dropping hole 3-16 to 6-16 and is discharged through the punching scrap conveyer 3-19 to 6-19. The punching scrap generated continuously falls in connection from the punch upper direction, but due to the two to eight pieces of the lower scrrap cutters 3-8 to 6-8 set at lower direction of the punch outer circumferential part, one large ring scrap connected in ring shape is distributed and cut to the two to eight pieces of scrap, and as above described, is discharged to the outside of the metal mold in prescribed passage and order.

As measure that the scrap of small quantity existing at the upper and lower surface part of the ring material 1b or the drive plate material 1f does not give the striking flaw to an article, air jet 3-17 to 6-17 directed to the lower surface part are formed at the punch upper surface part and air jet holes 3-18 or 6-18 directed to the upper mold female die recess are provided on the upper mold female die 3-1 or 6-1, and by the air blow, at the intermitted or steady blowing, a production method performing the forced exhaust of the scrap of small amount becomes possible. Thereby a ring gear or a drive plate gear (refer to FIG. 15) manufactured is finished at significantly high precision at the fourth class of the JIS standard. As shown in FIG. 6, when two metal molds are arranged in parallel and the transfer device is installed and manufacturing is performed, 30 pieces of rings per one minute can be manufactured, and in comparison to the cutting machining in the prior art, the manufacturing speed becomes about 20 times and the manufacturing method of the ring gear or the driven gear at the low cost can be provided. Further, although not shown, a manufacturing method of metal mold of ring shaped material and metal mold for the ring material and the drive plate material, thus three metal molds are arranged in parallel. Thereby the rationalization is further advanced and the manufacturing method of the ring gear of the drive gear at low price can be provided,

What is claimed is:

1. A method of manufacturing rings for a starter using a press, comprising, step that a coil material of special steel is cut and a ring coil material for a starter is formed, and both ends of the ring coil material for a starter are connected and a ring-shaped material is manufactured;
step that when the ring-shaped material is punched using a press and a ring material is manufactured, a punch is set at center part of a lower metal mold, and four knockout pins are installed at lower side of the ring-shaped material projected in 1 mm to 9 mm from the upper surface of the punch, and the ring-shaped material is held on the knockout pins, and a female die is set on lower side of the upper metal mold, and thickness of an outer circumferential part of the ling material is made thicker by 1 mm to 5 mm than that of an inner circumferential part of the ring material;
step that the female die is constituted by a gear formed on the outer circumference from the inlet to the bottom part and a chamfer formed at the bottom part, and the female die is formed in a taper with four stages of 10 degrees to 30 degrees from the inlet toward the bottom part, and length of the taper holds the thickness of the ring material in 30% to 100%, and in taper of four stages, the first stage is positioned on the diameter of the addendum circle from the lower surface side of the female die toward the upper deep part of the female die, and the second stage is positioned at the intermediate position of the diameter of the basic circle pitch and the diameter of the addendum circle, and the third stage is positioned on the diameter or the basic circle pitch, and the fourth stage is positioned at the intermediate position of the diameter of the basic circle pitch and the tooth bottom, moreover a land part is provided at the front side of the taper with four stages, and the length of the land part is less than the thickness of the ring material, and a release part of the taper shape is formed at the front side of the taper, or a straight release part in about 1 mm of the diameter is formed in the tooth form as a whole, and the length of the release part is made longer by 140% or more of the thickness of the ring material, and the angle of the taper release part is held from 2 degrees to 6 degrees, and applied pressure necessary for the molding of the gear of the outer circumferential part is punching force in the necessary minimum limit and the gear is provided on the outer circumferential part of the ring material; and
step that the applied pressure to the ling material formed in the punching step is temporarily made free state immediately attaining to the bottom dead center of the press and at height from the molding height of the chamfering to the bottom dead center of the press, chamfering machining is performed on the gear or on a part of the gear,
wherein the punching of tooth form of the gear and the chamfering to a part of the gear are performed in one step.

2. A method of manufacturing rings for a starter using a press, comprising; step that a material of special steel is subjected to press machining and a ring-shaped material for a starter is manufactured;
step that when the ring-shaped matertial is punched using a press and a ring material is manufactured, a punch is set at center part of a lower metal mold, and four knockout pins are installed at lower side of the ring-shaped material projected in 1 mm to 9 mm from the upper surface of the punch, and the ring-shaped material is held on the knockout pins, and a female die is set on lower side of the upper metal mold, and thickness of an outer circumferential part of the ring material is made thicker by 1 mm to 5 mm than that of an inner circumferential part of the ring material;
step that the female die is constituted by a gear formed on the outer circumference from the inlet to the bottom part and a chamfer formed at the bottom part, and the female die is formed in a taper with four stages of 10 degrees to 30 degrees from the inlet toward the bottom part, and length of the taper holds the thickness of the ring material in 30% to 100%, and in taper of four stages, the first stage is positioned on the diameter of the addendum circle from the lower surface side of the female die toward the upper deep part of the female die, and the second stage is positioned at the intermediate position of the diameter of the basic circle pitch and the diameter of the addendum circle, and the third stage is positioned on the diameter of the basic circle pitch, and the fourth stage is positioned at the intermediate position of the diameter of the basic circle pitch and the tooth bottom, moreover a land part is provided at the front side of the taper with four stages, and the length of the land part is less than the thickness of the ring matertial, and release part of the taper shape is formed at the front side of the taper, or a straight release part in about 1 mm of the diameter is formed in the tooth form as a whole, and the length of the taper release part is made larger by 140% or more of the thickness of the ring matertial, and the angle of the taper release part is held from 2 degrees to 6 degrees, and applied pressure necessary for the molding of the gear of the outer circumferential part is punching force in the necessary minimum limit and the gear is provided on the outer circumferential part of the ring material; and
step that the applied pressure to the ring material formed in the punching step is temporarily made free state immediately attaining to the bottom dead center of the press and at height from the molding height of the chamfering to the bottom dead center of the press, chamfering machining is performed on the gear or on a part of the gear,
wherein the punching of tooth form of the gear and the chamfering machining to a part of the gear are performed in one step.

3. A method of manufacturing rings for a starter using a press as set forth in claim 1 or claim 2,
wherein in the first step, the crush molding is performed using special steel to enable the high-frequency quenching, and outer circumferential part of the material is thickened than the inner circumferntial part of the material in 1 mm to 5 mm so as to prevent the punching fall of the addendum of the gear,
and in the second step the ring material is formed, subsequently punching of the tooth form of the gear, and chamfering is performed at a part of the gear.
